(19) United States
(12) Patent Application Publication
(10) Pub. No.: US 2007/0132361 A1
(43) Pub. Date: Jun. 14, 2007

(54) BACKLIGHT ASSEMBLY AND DISPLAY DEVICE HAVING THE SAME

(75) Inventors: Du-Hwan Chung, Suwon-si (KR); Byung-Cheon Yoo, Cheongwon-gun (KR); Hyun-Chul Bae, Suwon-si (KR); Hea-Chun Lee, Suwon-si (KR)

Correspondence Address: CANTOR COLBURN, LLP, 55 GRIFFIN ROAD SOUTH, BLOOMFIELD, CT, 06002, US

(73) Assignee: Samsung Electronics Co., Ltd., Suwon-si (KR)

(21) Appl. No.: 11/610,792

(22) Filed: Dec. 14, 2006

(30) Foreign Application Priority Data
Jan. 13, 2006 (KR) 1020060003794
Dec. 14, 2005 (KR) 1020050122900
Jan. 20, 2006 (KR) 1020060006062

(51) Int. Cl. H01J 1/62; H01J 63/04

(52) U.S. Cl. 313/493

(57) ABSTRACT

A backlight assembly includes a flat fluorescent lamp, a buffering member and a bottom chassis. The flat fluorescent lamp includes a lamp body generating light and an electrode portion formed on the lamp body. The buffering member contacts the electrode portion and includes at least one hole. The bottom chassis includes a bottom plate and a sidewall to receive the flat fluorescent lamp and the buffering member and includes at least one hole.

The present application claims priority to Korean Patent Application No. 2005-122900, filed on Dec. 14, 2005, Korean Patent Application No. 2006-3794, filed on Jan. 13, 2006, and Korean Patent Application No. 2006-6062, filed on Jan. 20, 2006, and all the benefits accruing therefrom under 35 U.S.C. §119, the contents of which are hereby incorporated herein by reference in their entireties.

### BACKGROUND OF THE INVENTION

1. Field of the Invention

The present invention relates to a backlight assembly and a display device having the backlight assembly. More particularly, the present invention relates to a backlight assembly capable of improving heat radiation and a display device having the backlight assembly.

2. Description of the Related Art

A liquid crystal display (“LCD”) device is a type of flat panel display device that displays images using liquid crystal. The LCD device has various characteristics such as thinner thickness, lighter weight, lower power consumption, lower driving voltage, etc., than other types of display devices so that the LCD device has been used in various fields.

An LCD panel of the LCD device does not generate light, and is a non-emissive type display device. Thus, the LCD device requires a backlight assembly that supplies the LCD panel with the light.

A screen size of the LCD device has been increased. In order to decrease a manufacturing cost and to simplify a manufacturing process, a flat fluorescent lamp has been devised. The flat fluorescent lamp includes a lamp body and an external electrode. The lamp body includes a plurality of discharge spaces to generate the light. The external electrode applies a discharge voltage to the lamp body. The flat fluorescent lamp generates a plasma discharge in the discharge spaces based on the discharge voltage that is applied to the external electrode from an inverter. A fluorescent layer formed in the lamp body generates excitons based on ultraviolet light generated by the plasma discharge so that visible light is generated by the excitons.

However, a temperature difference is formed between an electrode portion of the flat fluorescent lamp on which the external electrode is formed and a central portion of the flat fluorescent lamp. Mercury in the discharge spaces is concentrated on the central portion by the temperature difference so that argon is excited in the electrode portion. When the argon is excited in the electrode portion, pink light is generated, thereby forming a pinky phenomenon.

### BRIEF SUMMARY OF THE INVENTION

An exemplary embodiment provides a backlight assembly capable of improving heat radiation.

An exemplary embodiment provides a display device having the above-mentioned backlight assembly.

An exemplary embodiment of a backlight assembly includes a flat fluorescent lamp, a buffering member and a bottom chassis. The flat fluorescent lamp includes a lamp body generating light and an electrode portion formed on the lamp body. The buffering member contacts the electrode portion and includes at least one hole. The bottom chassis includes a bottom plate and a sidewall to receive the flat fluorescent lamp and the buffering member and also includes at least one hole.

An exemplary embodiment of a backlight assembly includes a flat fluorescent lamp, a buffering member, a bottom chassis and a heat radiating member. The flat fluorescent lamp includes a lamp body generating light and an electrode portion formed on the lamp body. The buffering member contacts the electrode portion and includes at least one groove. The bottom chassis includes a bottom plate and a sidewall to receive the flat fluorescent lamp and the buffering member, and also includes a hole corresponding to the groove of the buffering member. The heat radiating member is combined with the groove of the buffering member through the hole of the bottom chassis.

An exemplary embodiment of a backlight assembly includes a flat fluorescent lamp, a buffering member and a bottom chassis. The flat fluorescent lamp includes a lamp body generating light and an electrode portion formed on the lamp body. The buffering member contacts the electrode portion and includes at least one heat radiating pin. The bottom chassis includes a bottom plate and a sidewall to receive the flat fluorescent lamp and the buffering member and also includes at least one hole through which the heat radiating pin is exposed.

An exemplary embodiment of a display device includes a backlight assembly and a display unit. The backlight assembly supplies light and includes a flat fluorescent lamp, a buffering member and a bottom chassis. The flat fluorescent lamp includes a lamp body generating the light, a first external electrode on an upper surface of the lamp body and a second external electrode on a lower surface of the lamp body. The buffering member contacts the second external electrode and includes at least one hole. The bottom chassis includes a bottom plate and a sidewall to receive the flat fluorescent lamp and the buffering member and also includes at least one hole. The display unit displays images based on the light generated from the backlight assembly.

An exemplary embodiment of a display device includes a backlight assembly and a display unit. The backlight assembly supplies light, and includes a flat fluorescent lamp, a buffering member, a bottom chassis and a heat radiating member. The flat fluorescent lamp includes a lamp body generating the light, a first external electrode on an upper surface of the lamp body and a second external electrode on a lower surface of the lamp body. The buffering member contacts the second external electrode and includes at least one groove. The bottom chassis includes a bottom plate and a sidewall to receive the flat fluorescent lamp and the buffering member and also includes a hole corresponding to the groove of the buffering member. The heat radiating member is combined with the groove of the buffering member through the hole of the bottom chassis. The display unit displays images based on the light generated from the backlight assembly.

An exemplary embodiment of a display device includes a backlight assembly and a display unit. The backlight assembly supplies light and includes a flat fluorescent lamp, a buffering member and a bottom chassis. The flat fluorescent lamp includes a lamp body generating light, a first external electrode on an upper surface of the lamp body, and a second external electrode on a lower surface of the lamp body. The buffering member contacts the second external electrode and includes at least one heat radiating pin. The bottom chassis includes a bottom plate and a sidewall to receive the flat fluorescent lamp and the buffering member and also includes at least one hole through which the heat radiating pin is exposed. The display unit displays images based on the light generated from the backlight assembly.

In an exemplary embodiment, the heat generated from the flat fluorescent lamp is easily radiated, thereby decreasing a pinky phenomenon on the flat fluorescent lamp.

### BRIEF DESCRIPTION OF THE DRAWINGS

The above and other advantages of the present invention will become more apparent by describing in detail example embodiments thereof with reference to the accompanying drawings, in which:

FIG. 1 is an exploded perspective view illustrating an exemplary embodiment of a backlight assembly in accordance with the present invention;

FIG. 2 is a cross-sectional view illustrating the backlight assembly shown in FIG. 1;

FIG. 3 is a perspective view illustrating an exemplary embodiment of a flat fluorescent lamp in accordance with the present invention;

FIG. 4 is a cross-sectional view taken along line I-I′ shown in FIG. 3;

FIG. 5 is an exploded perspective view illustrating an exemplary embodiment of a liquid crystal display (“LCD”) device in accordance with the present invention;

FIG. 6 is a graph showing a temperature distribution of an exemplary embodiment of a backlight assembly in accordance with the present invention;

FIG. 7 is a perspective view illustrating another exemplary embodiment of a backlight assembly in accordance with the present invention;

FIG. 8 is an exploded perspective view illustrating a rear surface of the backlight assembly shown in FIG. 7;

FIG. 9 is a cross-sectional view illustrating the backlight assembly shown in FIG. 7;

FIG. 10 is a graph showing a temperature distribution of an exemplary embodiment of a flat fluorescent lamp in accordance with the present invention;

FIG. 11 is an exploded perspective view illustrating another exemplary embodiment of a backlight assembly in accordance with the present invention;

FIG. 12 is an exploded perspective view illustrating a rear surface of the backlight assembly shown in FIG. 11; and

FIG. 13 is a cross-sectional view illustrating the backlight assembly shown in FIG. 11.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

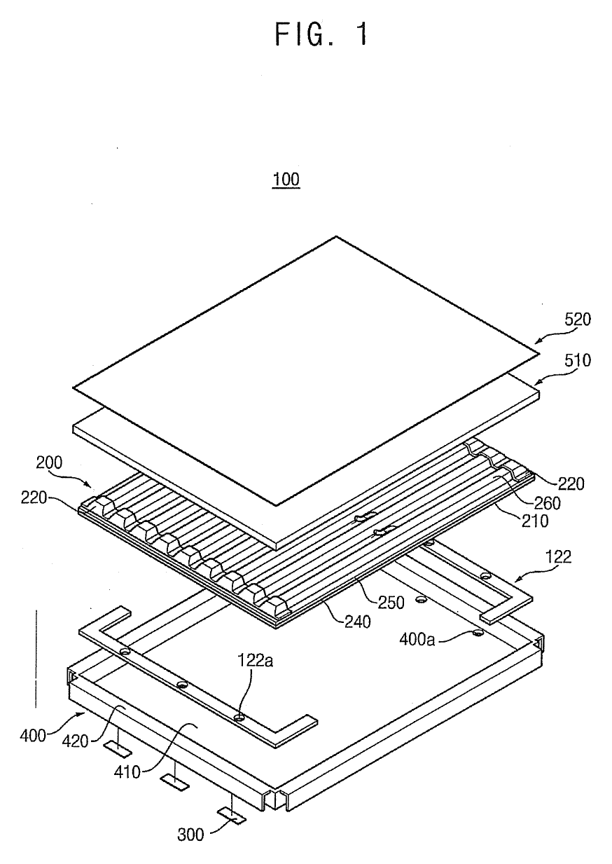

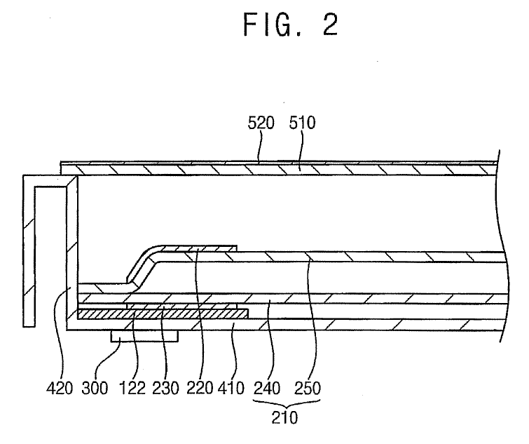

FIG. 1 is an exploded perspective view illustrating an exemplary embodiment of a backlight assembly in accordance with the present invention. FIG. 2 is a cross-sectional view illustrating the backlight assembly shown in FIG. 1.

Referring to FIGS. 1 and 2, the backlight assembly 100 includes a flat fluorescent lamp 200 and a bottom chassis 400.

The flat fluorescent lamp 200 includes a lamp body 210, a first external electrode 220 and a second external electrode 230. Light is generated in the lamp body 210. The first external electrode 220 is formed on an upper surface of the lamp body 210. The second external electrode 230 is formed on a lower surface of the lamp body 210.

The lamp body 210 includes a first substrate 240 and a second substrate 250. The second substrate 250 is combined with the first substrate 240 to form a plurality of discharge spaces 260. In an exemplary embodiment, the second substrate 250 may be formed by molding. The lamp body 210 may have a substantially quadrangular shape when viewed on a plane to generate a planar shaped light.

When a discharge voltage from an externally provided inverter (not shown) is applied to the first and second external electrodes 220 and 230, a plasma discharge is generated in the discharge spaces 260. The lamp body 210 changes ultraviolet light generated by the plasma discharge into visible light and emits the visible light. The lamp body 210 has a relatively wide light emitting surface and includes a plurality of discharge spaces 260 to increase light emitting efficiency.

The first external electrode 220 is formed on the upper surface of the lamp body 210. In one exemplary embodiment, the first external electrode 220 is formed on an external surface of the second substrate 250. The second external electrode 230 is formed on the lower surface of the lamp body 210. In an alternative exemplary embodiment, the second external electrode 230 is formed on an external surface of the first substrate 240. The first and second external electrodes 220 and 230 are formed on end portions of the first and second substrates 250 and 240, respectively, so that the first external electrode 220 faces the second external electrode 230. The first and second substrates 250 and 240 are interposed between the first and second external electrodes 220 and 230.

The first and second external electrodes 220 and 230 cross the discharge spaces 260 in a transverse direction of the discharge spaces 260 such that the discharge voltage is applied to the discharge spaces 260. The first and second external electrodes 220 and 230 correspond in location and/or position to opposite end portions of the discharge spaces 260 taken in a longitudinal direction of the discharge spaces 260.

A buffering member 122 is interposed between the flat fluorescent lamp 200 and the bottom chassis 400. The flat fluorescent lamp 200 is spaced apart from the bottom chassis 400 by the buffering member 122 such that the flat fluorescent lamp 200 is electrically insulated from the bottom chassis 400. In an exemplary embodiment illustrated in FIGS. 1 and 2, the buffering member 122 may include an elastic material to absorb an externally provided impact. In exemplary embodiments, the buffering member 122 may include, but is not limited to, silicon, synthetic rubber, etc., for electrically insulating and buffering the flat fluorescent lamp 200.

In an exemplary embodiment, in order to increase heat radiation, the buffering member 122 may have a thermal conductivity of more than a predetermined value. In one exemplary embodiment, the buffering member 122 has a thermal conductivity of more than about 3 W/mK to conduct the heat between the flat fluorescent lamp 200 and the bottom chassis 400. In one exemplary embodiment illustrated in FIGS. 1 and 2, the buffering member 122 includes a silicon matrix and conductive particles in the silicon matrix. The conductive material that can be used for the buffering member 122 includes, but is not limited to, carbon (C), aluminum (Al), etc. The buffering member 122 may further have a hole 122a as illustrated in FIG. 1. A portion of the heat is convected in the hole 122a of the buffering member 122 to increase an amount of the heat radiation. The portion of the heat generated from an electrode portion of the flat fluorescent lamp 200 (e.g. a portion of the flat fluorescent lamp 200 corresponding to an external electrode, such as at ends of the flat fluorescent lamp 200) is convected in the hole 122a of the buffering member 122, thereby dissipating the portion of the heat. Advantageously, the temperature difference between the electrode portion and the central portion of the flat fluorescent lamp 200 is decreased so that mercury is not concentrated on the central portion, thereby decreasing a pinky phenomenon.

The bottom chassis 400 includes a bottom plate 410 and a sidewall 420. The sidewall 420 is protruded from sides of the bottom plate 410 to form a receiving space for receiving the flat fluorescent lamp 200. The bottom chassis 400 may include a relatively strong metal having high thermal conductivity. In exemplary embodiments, the bottom plate 410 of the bottom chassis 400 may have a hole 400a as illustrated in FIG. 1 to dissipate the heat from the buffering member 122 through a heat conduction. In an exemplary embodiment, when the hole 400a of the bottom chassis 400 corresponds substantially in shape, size and/or location to the hole 122a of the buffering member 122, an amount of the heat dissipation may be increased. In one exemplary embodiment, an insulating cover 300 may cover the hole 400a of the bottom chassis 400 so that foreign or stray particles may not be inserted into the hole 400a of the bottom chassis 400 and/or the hole 122a of the buffering member 122, and/or the light may not leak through the hole 400a of the bottom chassis 400 or the hole 122a of the buffering member 122. In exemplary embodiments, the insulating cover 300 may be black.

The backlight assembly 100 may further include a diffusion plate 510 and at least one optical sheet 520. The diffusion plate 510 and the optical sheet 520 are disposed on the flat fluorescent lamp 200.

The diffusion plate 510 diffuses the light generated from the flat fluorescent lamp 200 to increase luminance uniformity of the light. The diffusion plate 510 has a substantially plate shape having a predetermined thickness. The diffusion plate 510 is spaced apart from the flat fluorescent lamp 200 by a predetermined distance. In one exemplary embodiment, the diffusion plate 510 includes polymethyl methacrylate (PMMA) and diffusing agent for diffusing the light.

The optical sheet 520 guides the light having passed through the diffusion plate 510 to increase optical characteristics of the light. In exemplary embodiments, the optical sheet 520 may include a brightness enhancement sheet that guides the light toward a center of the backlight assembly 100 to increase a luminance when viewed on a plane. In an exemplary embodiment, the optical sheet 520 may further include a diffusion sheet that diffuses the diffused light that is diffused by the diffusion plate 510 to increase a luminance uniformity of the diffused light. The number of sheets of the optical sheet may be changed based on luminance characteristics of the backlight assembly 100.

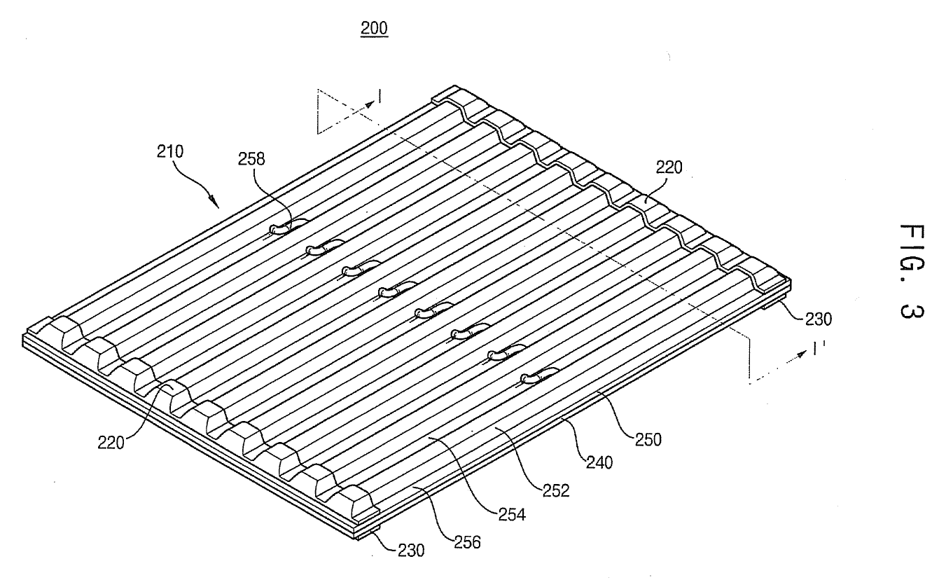

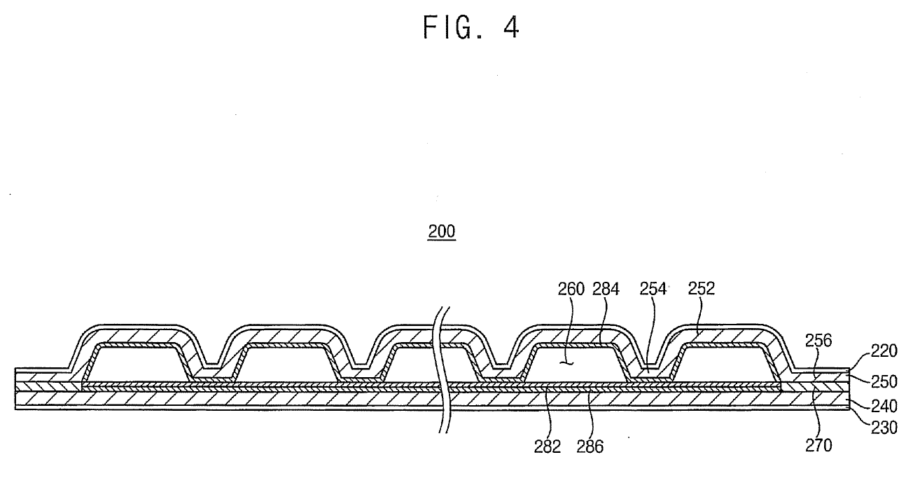

FIG. 3 is a perspective view illustrating an exemplary embodiment of a flat fluorescent lamp in accordance with the present invention. FIG. 4 is a cross-sectional view taken along line I-I′ shown in FIG. 3.

Referring to FIGS. 3 and 4, the flat fluorescent lamp 200 includes a lamp body 210, a first external electrode 220 and a second external electrode 230. Light is generated in the lamp body 210. The first external electrode 220 is on an upper surface of the lamp body 210. The second external electrode 230 is on a lower surface of the lamp body 210.

The lamp body 210 includes a first substrate 240 and a second substrate 250. The second substrate 250 is combined with the first substrate 240 to form a plurality of discharge spaces 260.

The first substrate 240 has a substantially plate shape. In one exemplary embodiment, the first substrate 240 includes a glass substrate, a quartz substrate, etc. The first substrate 240 may include ultraviolet light blocking material to block ultraviolet light that is from the discharge spaces 260.

In exemplary embodiments the second substrate 250 may be molded to form the discharge spaces 260. The second substrate 250 transmits visible light generated in the discharge spaces 260. In one exemplary embodiment, the second substrate 250 may include a glass substrate, a quartz substrate, etc. The second substrate 250 may include ultraviolet light blocking material to block ultraviolet light that is from the discharge spaces 260.

In exemplary embodiments, the second substrate 250 may be molded by various methods. In one exemplary embodiment, a glass substrate having a substantially same plate shape as the first substrate 240 may be heated and molded using a cast to form the second substrate 250. In an alternative embodiment, the second substrate 250 may be formed through a blow molding. In the blow molding, the glass substrate having the substantially plate shape may be heated and pressed by air to form the second substrate 250.

The second substrate 250 includes a plurality of discharge space portions 252, a plurality of space dividing portions 254 and a sealing portion 256 to form the discharge spaces 260. The discharge space portions 252 are spaced apart from the first substrate 240 to form the discharge spaces 260. The space dividing portions 254 make contact with the first substrate 240 between the discharge space portions 252 to divide an internal space into the discharge spaces 260. A cross-section of the discharge space portions 252 of the second substrate 250 may be considered to have a plurality of arches connected to each other. In an alternative embodiment, the cross-section of the discharge space portions 252 of the second substrate 250 may have a substantially semicircular shape, a substantially quadrangular shape, a substantially trapezoidal shape, etc.

A connecting passage 258 is formed on the second substrate 250 to connect the discharge spaces 260 adjacent to each other. As illustrated in FIGS. 3 and 4, at least one connecting passage 258 is formed on each of the space dividing portions 254. An air in the discharge spaces 260 may be discharged through the connecting passage 258. Discharge gas injected into one of the discharge spaces 260 may pass through the connecting passage 228 so that pressure in the discharge spaces 260 is substantially equal to one another. The connecting passage 258 may be formed through the molding process to form the second substrate 250. The connecting passage 258 may have various shapes to connect the adjacent discharge spaces 260. In one exemplary embodiment, the connecting passage 258 may have an ‘S’ shape. When the connecting passage 258 has the ‘S’ shape, a path length between the adjacent discharge spaces 260 is increased so that the discharge gas may not be concentrated on one of the discharge spaces 260.

The first substrate 240 is combined with the second substrate 250 through combining member 270, such as an adhesive. In an exemplary embodiment, the adhesive 270 may include a frit that is a mixture of glass and metal and a melting point of the frit is lower than pure glass. The adhesive 270 is prepared between the first and second substrates 240 and 250 corresponding to the sealing portion 256 of the second substrate 250 and the adhesive 270 is fired and solidified, thereby combining the first substrate 240 with the second substrate 250. In one exemplary embodiment, the adhesive 270 is fired at a temperature of about 400° C. to about 600° C.

The space dividing portions 254 of the second substrate 250 are combined with the first substrate 240 by a pressure difference between the discharge spaces 260 and an outside of the flat fluorescent lamp 200. In one exemplary embodiment, the first substrate 240 is combined with the second substrate 250 and the air between the first and second substrates 240 and 250 is discharged so that the discharge spaces 260 are evacuated. The discharge gas is injected into the evacuated discharge spaces 260. Exemplary embodiments of the discharge gas include, but are not limited to, mercury (Hg), neon (Ne), argon (Ar), etc.

In the illustrated exemplary embodiment in FIGS. 3 and 4, the pressure of the discharge gas in the discharge spaces 260 is about 50 Torr to about 70 Torr, and an atmospheric pressure of outside of the flat fluorescent lamp 200 is about 760 Torr, thereby forming the pressure difference. Therefore, a force from the outside of the lamp body 210 toward the inside of the lamp body 210 is formed so that the space dividing portions 254 make contact with the first substrate 240.

Referring to FIG. 4, the flat fluorescent lamp 200 may further include a first fluorescent layer 282 and a second fluorescent layer 284. The first fluorescent layer 282 is disposed on an inner surface of the first substrate 240 and the second fluorescent layer 284 is disposed on an inner surface of the second substrate 250. When the ultraviolet light generated in the discharge spaces 260 by plasma discharge is irradiated onto the first and second fluorescent layers 282 and 284, excitons are generated from the first and second fluorescent layers 282 and 284, thereby generating the visible light.

The flat fluorescent lamp 200 may further include a reflecting layer 286 interposed between the first substrate 240 and the first fluorescent layer 282. The visible light generated from the first and second fluorescent layers 282 and 284 are reflected from the reflecting layer 286 so that the visible light may not be leaked through the first substrate 240. In one exemplary embodiment, the reflecting layer 286 may include highly reflective material that may not change color coordinates of the reflected light. Exemplary embodiments of the highly reflective material that can be used for the reflecting layer 286 include, but are not limited to, aluminum oxide (Al₂O₃), barium sulfate (BaSO₄), etc.

In an exemplary embodiment, fluorescent material and the highly reflective material may be sprayed on the first and second substrates 240 and 250 to form the first and second fluorescent layers 282 and 284 and the reflecting layer 286 as a thin film shape. The first and second fluorescent layers 282 and 284 and the reflecting layer 286 may be formed on the first and second substrates 240 and 250 except a region corresponding to the sealing portion 256 as illustrated in FIG. 4. In an alternative embodiment, the first and second fluorescent layers 282 and 284 and the reflecting layer 286 may not be formed on the space dividing portions 254.

In an exemplary embodiment, the flat fluorescent lamp 200 may further include a protecting layer (not shown) formed between the first substrate 240 and the reflecting layer 286 and/or between the second substrate 250 and the second fluorescent layer 284. The protecting layer reduces or effectively prevents a chemical reaction between the first and second substrates 240 and 250 and the mercury of the discharge space so that an amount of the mercury in the discharge gas may not be decreased and a black spot is not formed on the first and second substrates 240 and 250.

As illustrated in FIGS. 3 and 4, the first and second external electrodes 220 and 230 are formed on an upper surface and a lower surface of the lamp body 210, respectively. Each of the first and second external electrodes 220 and 230 crosses in a substantially transverse direction of the discharge spaces 260 so that the discharge voltage may be applied to the discharge spaces 260. Each of the first and second external electrodes 220 and 230 are on opposite end portions of the discharge spaces 260 taken in a longitudinal direction of the discharge spaces 260. The first and second external electrodes 220 and 230 on the upper and lower surfaces of the lamp body 210 are electrically connected to each other through a connecting member such as a conductive clip (not shown). In exemplary embodiments, the first external electrode 220 may be integrally formed with the second external electrode 230 along a side surface of the lamp body 210 to increase an amount of heat radiation.

The first and second external electrodes 220 and 230 may include conductive material to transmit the discharge voltage that is from an external inverter (not shown). In one exemplary embodiment, a silver paste that is a mixture of silver (Ag) and silicon oxide (SiO2) may be coated on the lamp body 210 to form the first and second external electrodes 220 and 230. In an alternative exemplary embodiment, the first and second external electrodes 220 and 230 may be formed through a spray method, a spin coating method, a dipping method, etc. The first and second external electrodes 220 and 230 may be formed by using metal sockets.

In FIGS. 3 and 4, the lamp body 210 includes the first substrate 240 and the molded second substrate 250 to form the discharge spaces 260. In alternative embodiments, the second substrate 250 may have substantially the same plate shape as the first substrate 240, and a plurality of partition walls may be interposed between the first and second substrates 240 and 250 to form the discharge spaces 260.

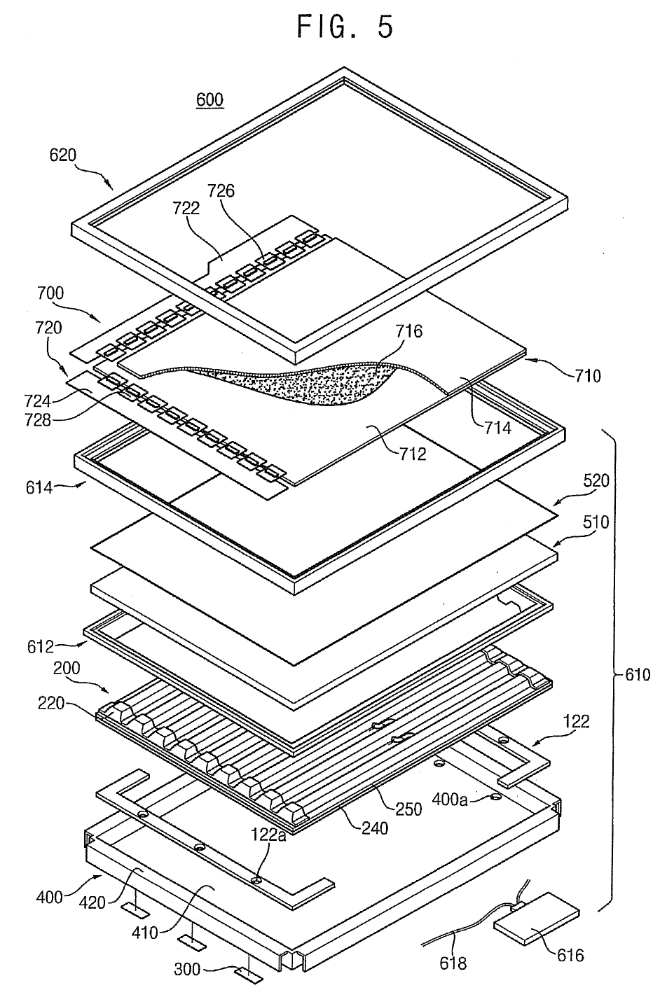

FIG. 5 is an exploded perspective view illustrating an exemplary embodiment of a liquid crystal display (“LCD”) device in accordance with the present invention.

Referring to FIG. 5, the display device 600 includes a backlight assembly 610 and a display unit 700. The backlight assembly 610 generates light. The display unit 700 displays images based on the light generated from the backlight assembly 610.

The backlight assembly of FIG. 5 is substantially the same as in FIGS. 1 to 4 except a first mold 612, a second mold 614 and an inverter 616. Thus, the same reference numerals will be used to refer to the same or like parts as those described in FIGS. 1 to 4 and any further explanation concerning the above elements will be omitted.

The backlight assembly 610 may further include the first mold 612 interposed between a flat fluorescent lamp 200 and a diffusion plate 510. The first mold 612 holds sides of the flat fluorescent lamp 200 to fix peripheral portions of the diffusion plate 510 and the diffusion sheet 520 to the flat fluorescent lamp 200. The first mold 612 may include a side protruding from an upper surface of the first mold 612 towards the flat fluorescent lamp 200 that includes a profile substantially corresponding to that of an upper surface of the flat fluorescent lamp 200. In an exemplary embodiment, the first mold 612 may also press a buffering member 122 through the flat fluorescent lamp 200 so that the buffering member 122 makes contact with the second external electrode 230 of the flat fluorescent lamp 200.

The first mold 612 may have an integrally formed frame shape. In an alternative embodiment, the first mold 612 may include two U-shaped pieces or two L-shaped pieces connected to form the first mold 612. The first mold 612 may include four pieces corresponding to four corners of the flat fluorescent lamp 200.

Referring to FIG. 5, the backlight assembly 610 may further include the second mold 614 interposed between the optical sheet 520 and a display unit 700. The second mold 614 fixes the diffusion plate 510 and the optical sheet 520 to the first mold 612 and supports a peripheral portion of a liquid crystal display (“LCD”) panel 710. In an alternative embodiment, the second mold 614 may be integrally formed with the first mold 612. The second mold 614 may include two pieces having various shapes or four pieces corresponding to the four corners of the flat fluorescent lamp 200.

The backlight assembly 610 may further include the inverter 616 to apply a discharge voltage to the flat fluorescent lamp 200. The inverter 616 may be disposed on an outer (or rear) surface of the bottom chassis 400. The inverter 616 elevates a level of an alternating current that is from an exterior to the inverter 616 to apply the discharge voltage having the elevated level to the flat fluorescent lamp 200. The discharge voltage generated from the inverter 616 is applied to the first and second external electrodes 220 and 230 through a power supply line 618.

The display unit 700 includes the LCD panel 710 and a driving circuit part 720. The LCD panel 710 displays the images based on the light generated from the backlight assembly 610. The driving circuit part 720 drives the LCD panel 710.

The LCD panel 710 includes a first display substrate 712, a second display substrate 714 and a liquid crystal layer 716. The second display substrate 714 faces and is combined with the first display substrate 712. The liquid crystal layer 716 is interposed between the first and second display substrates 712 and 714.

The first display substrate 712 includes a thin film transistor substrate including a plurality of switching elements that are thin film transistors (“TFT”). In exemplary embodiments, the first display substrate 712 includes a glass substrate. A source electrode and a gate electrode of each of the thin film transistors are electrically connected to a data line and a gate line, respectively. A drain electrode of each of the thin film transistors is electrically connected to a pixel electrode including a transparent conductive material.

The second display substrate 714 includes a color filter substrate including red, green and blue pixels having a thin film shape to display color images. In exemplary embodiments, the second display substrate 714 includes a glass substrate. The second display substrate 714 may further include a common electrode including a transparent conductive material.

When a voltage is applied to the gate electrode of each of the thin film transistors, the thin film transistor of the LCD panel 710 is turned on so that an electric field is formed between the pixel electrode and the common electrode. Liquid crystals of the liquid crystal layer 716 interposed between the first and second substrates 712 and 714 vary arrangement in response to the electric field applied thereto, and light transmittance of the liquid crystal layer 716 is changed, thereby displaying the images having a predetermined gray-scale.

The driving circuit part 720 includes a data printed circuit board 722, a gate printed circuit board 724, a data driving circuit film 726 and a gate driving circuit film 728. The data printed circuit board 722 applies a data driving signal to the LCD panel 710. The gate printed circuit board 724 applies a gate driving signal to the LCD panel 710. The data printed circuit board 722 is electrically connected to the LCD panel 710 through the data driving circuit film 726. The gate printed circuit board 724 is electrically connected to the LCD panel 710 through the gate driving circuit film 728. In an exemplary embodiment, each of the data and gate driving circuit films 726 and 728 may be a tape carrier package (“TCP”) or a chip on film (“COF”). In an alternative embodiment, a signal line (not shown) may be formed on the LCD panel 710 and the gate driving circuit film 728 so that the gate printed circuit board 724 may be omitted.

The display device 600 may further include a top chassis 620 to fix the display unit 700 to the backlight assembly 610. The top chassis 620 is combined with the bottom chassis 400 to fix a peripheral portion of the LCD panel 710 to the backlight assembly 610. The data driving circuit film 726 is bent toward a side surface or a rear surface of the bottom chassis 400 so that the data printed circuit board 722 is mounted on the side surface and/or the rear surface of the bottom chassis 400. The top chassis 620 may include a strong metal that is resistant to deformation.

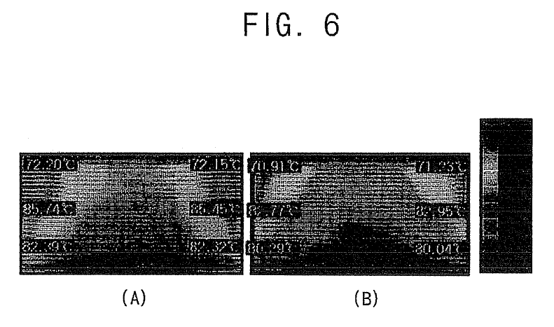

FIG. 6 is a graph showing a temperature distribution of an exemplary embodiment of a backlight assembly in accordance with the present invention. Graph (A) of FIG. 6 represents a temperature distribution of a lamp in a backlight assembly in accordance with the present invention, which has a buffering member and a bottom chassis without a hole. Graph (B) of FIG. 6 represents a temperature distribution of a lamp in a backlight assembly in accordance with the present invention, which has a buffering member and a bottom chassis having holes.

Referring to FIGS. 1 and 6, a temperature distribution of the lamp 200 having the buffering member 122 and the bottom chassis 400 that have the holes 122a and 400a, respectively, is more uniformized than that of the lamp having the buffering member and the bottom chassis without the hole. When the uniformity of the temperature distribution is increased, mercury is not concentrated on a central portion of the flat fluorescent lamp 200, thereby decreasing the pinky phenomenon.

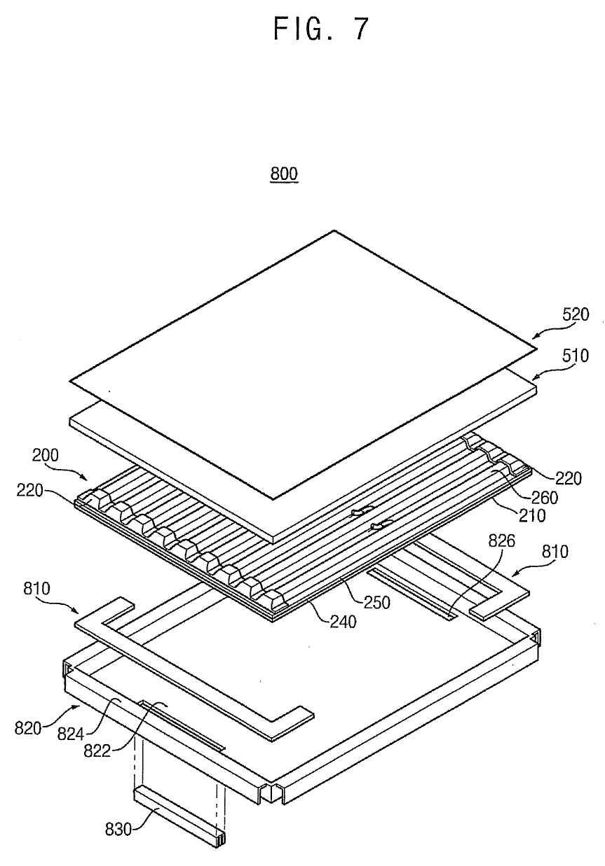

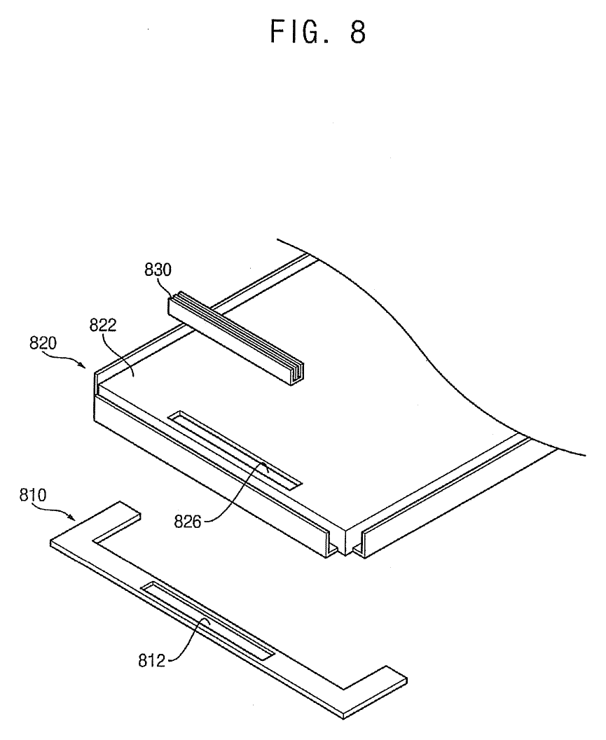

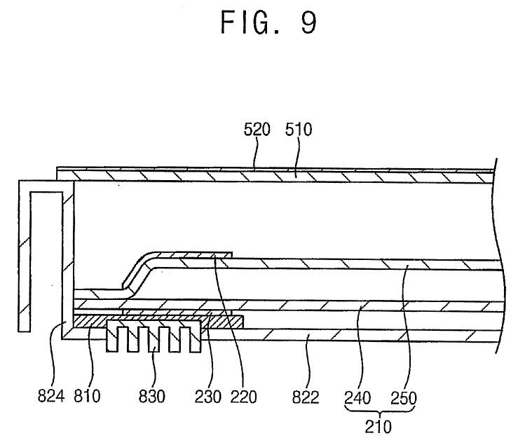

FIG. 7 is a perspective view illustrating another exemplary embodiment of a backlight assembly in accordance with the present invention. FIG. 8 is an exploded perspective view illustrating a rear surface of the backlight assembly shown in FIG. 7. FIG. 9 is a cross-sectional view illustrating the backlight assembly shown in FIG. 7.

Referring to FIGS. 7 to 9, the backlight assembly 800 includes a flat fluorescent lamp 200, a buffering member 810, a bottom chassis 820 and a heat radiating member 830.

The flat fluorescent lamp 200 of FIGS. 7 to 9 is same as in FIGS. 3 and 4. Thus, the same reference numerals will be used to refer to the same or like parts as those described in FIGS. 3 and 4 and any further explanation concerning the above elements will be omitted.

The buffering member 810 is interposed between the flat fluorescent lamp 200 and the bottom chassis 820. The buffering member 810 makes contact with a second external electrode 230 of the flat fluorescent lamp 200. The flat fluorescent lamp 200 is spaced apart from the bottom chassis 820 by the buffering member 810 so that the flat fluorescent lamp 200 is electrically disconnected from the bottom chassis 820 including metal. In exemplary embodiments, the buffering member 810 may include an elastic material to absorb an externally provided impact. The buffering member 810 may include silicone for electrically insulating and buffering the flat fluorescent lamp 200.

In an exemplary embodiment, in order to increase heat radiation, the buffering member 810 may have a thermal conductivity of more than a predetermined value. In one exemplary embodiment, the buffering member 810 has a thermal conductivity of more than about 3 W/mK to conduct the heat between the flat fluorescent lamp 200 and the bottom chassis 820. As illustrated in FIGS. 7 to 9, the buffering member 810 includes a silicon matrix and conductive particles in the silicon matrix. Exemplary embodiments of conductive material that can be used for the buffering member 810 include carbon (C), aluminum (Al), etc.

The buffering member 810 may further include a groove 812 to be combined with the heat radiating member 830.

The bottom chassis 820 includes a bottom plate 822 and a sidewall 824. The sidewall 824 is extended from sides of the bottom plate 822 to form a receiving space to receive the flat fluorescent lamp 200. The bottom chassis 820 may include a strong metal that is resistant to deformation.

A hole 826 corresponding substantially in shape, size and/or location to the groove 812 of the buffering member 810 is formed on the bottom plate 822 of the bottom chassis 820. The shape and dimensions of the hole 826 may also correspond to that of the heat radiating member 830 such that the heat radiating member 830 is accepted through the hole 826.

The heat radiating member 830 is combined with the groove 812 of the buffering member 810 through the hole 826 of the bottom chassis 820. In exemplary embodiments, the heat radiating member 830 may be combined with the buffering member 810 through various methods such as adhesive, screw, hook, etc. A depth of the groove 812 is less than a thickness of the buffering member 810.

The heat radiating member 830 increases an amount of heat radiated from an electrode portion of the flat fluorescent lamp 200. In one exemplary embodiment, the heat radiating member 830 may be a heat sink that increases a surface of heat radiation. The heat sink may be inserted into the groove 812 of the buffering member 810 so that a thickness of the flat fluorescent lamp 200 is not increased although the flat fluorescent lamp 200 includes the heat sink.

In an alternative exemplary embodiment, the heat radiating member 830 may include a graphite plate that has a high horizontal thermal conductivity. In one exemplary embodiment, the graphite plate may have a thickness of about 0.075 millimeter (mm) to about 1.5 millimeters (mm). When a depth of the groove 812 of the buffering member 810 is about 1 mm, a current may not leak through the graphite plate. The graphite plate increases an amount of the heat radiation.

The heat radiating member 830 includes high thermal conductive and high electrical insulation material. In one exemplary embodiment, the heat radiating member 830 may include a boron nitride (BN), silicon carbide (SiC), magnesium oxide (MgO), aluminum oxide (Al₂O₃), etc. As illustrated in FIGS. 7-9, the heat radiating member 830 may be considered to have a “comb-like” profile with extending portions connected to a main part of the heat radiating member 830. An upper surface of the main part contacts the buffering member 810 in the groove 812. In alternative embodiments, the heat radiating member 830 may include any of a number of shapes, sizes and profiles as is suitable for the purpose described herein.

The heat radiating member 830 dissipates the heat generated from the electrode portion (e.g., portions proximate to the first and/or second electrodes 220 and 230) of the flat fluorescent lamp 200 to decrease a temperature difference between the electrode portion and portions at a distance away from the electrode portion (e.g., a central portion) of the flat fluorescent lamp 200. When the temperature difference of the flat fluorescent lamp 200 is decreased, mercury may not be concentrated on the central portion of the flat fluorescent lamp 200, thereby decreasing a pinky phenomenon on the electrode portion.

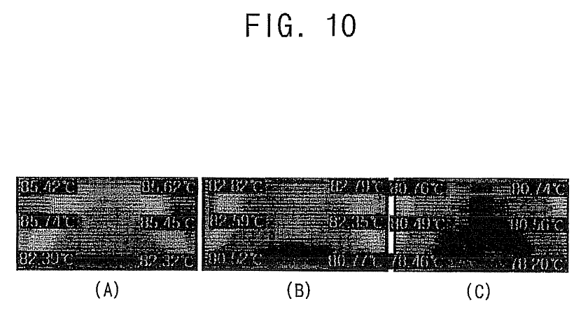

FIG. 10 is a graph showing a temperature distribution of an exemplary embodiment of a flat fluorescent lamp in accordance with the present invention. Graph (A) of FIG. 10 represents a temperature distribution of a lamp in a backlight assembly in accordance with the present invention, which does not have a heat radiating member. Graph (B) of FIG. 10 represents a temperature distribution of a lamp in a backlight assembly in accordance with the present invention, which has a heat radiating member formed on an outer surface of the bottom chassis. Graph (C) of FIG. 10 represents a temperature distribution of a lamp in a backlight assembly in accordance with the present invention, which has the heat radiating member, a hole of a bottom chassis and a groove of a buffering member.

Referring to FIGS. 7 and 10, a temperature distribution of the backlight assembly 800 having the heat radiating member 830 is more uniformized than that of the backlight assembly without the heat radiating member by about 2° C. In addition, a temperature distribution of the backlight assembly 800 having the heat radiating member 830, the hole 826 of the bottom chassis 820 and the groove 812 of the buffering member 810 is more uniformized than that of the backlight assembly without the hole 826 and the groove 812 by about 2° C. Advantageously, when the backlight assembly 800 includes the heat radiating member 830, the hole 826 and the groove 812, the uniformity of the temperature distribution is increased, and a thickness of the backlight assembly 800 may be decreased.

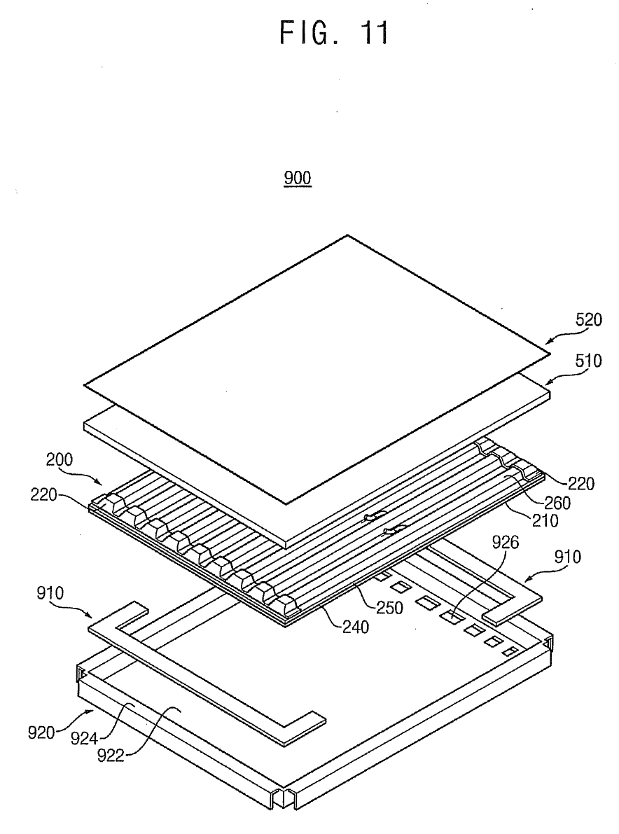

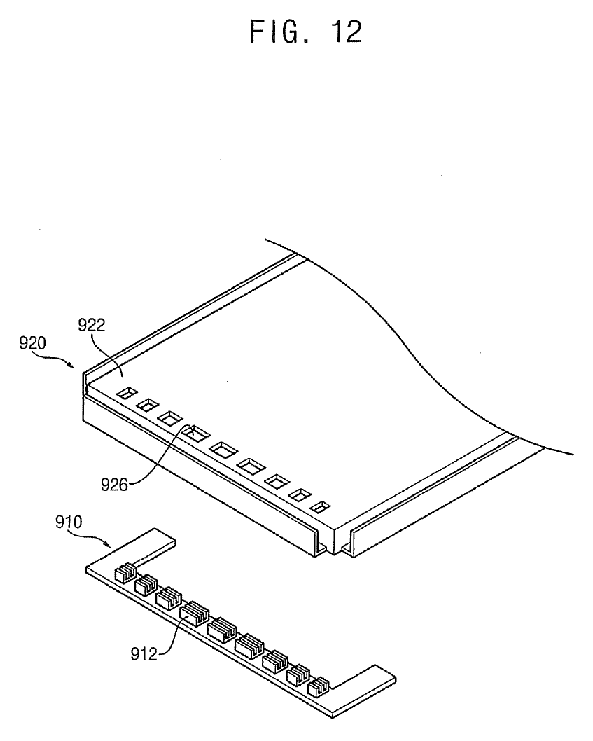

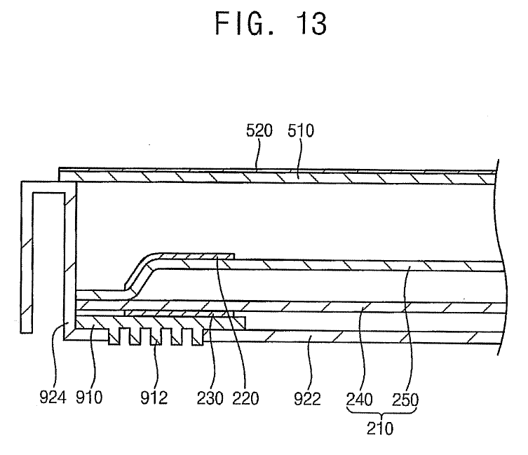

FIG. 11 is an exploded perspective view illustrating another exemplary embodiment of a backlight assembly in accordance with the present invention. FIG. 12 is an exploded perspective view illustrating a rear surface of the backlight assembly shown in FIG. 11. FIG. 13 is a cross-sectional view illustrating the backlight assembly shown in FIG. 11.

Referring to FIGS. 11 to 13, the backlight assembly 900 includes a flat fluorescent lamp 200, a buffering member 910 and a bottom chassis 920.

The backlight assembly 900 of FIGS. 11 to 13 is substantially the same as in FIGS. 3 and 4. Thus, the same reference numerals will be used to refer to the same or like parts as those described in FIGS. 3 and 4 and any further explanation concerning the above elements will be omitted.

The buffering member 910 is interposed between the flat fluorescent lamp 200 and the bottom chassis 920. The buffering member 910 makes contact with a second external electrode 230 of the flat fluorescent lamp 200. The flat fluorescent lamp 200 is spaced apart from the bottom chassis 920 by the buffering member 910 so that the flat fluorescent lamp 200 is electrically disconnected from the bottom chassis 920, which may include metal. The buffering member 910 may include an elastic material to absorb an externally provided impact. The buffering member 910 may include silicone for electrically insulating and buffering the flat fluorescent lamp 200.

In an exemplary embodiment, in order to increase heat radiation, the buffering member 910 may have a thermal conductivity of more than a predetermined value. In one exemplary embodiment, the buffering member 910 has a thermal conductivity of more than about 3 W/mK to conduct the heat between the flat fluorescent lamp 200 and the bottom chassis 920. In FIGS. 11 to 13, the buffering member 910 includes a silicon matrix and conductive particles in the silicon matrix. Exemplary embodiments of a conductive material that can be used for the buffering member 910 include carbon (C), aluminum (Al), etc.

The buffering member 910 includes at least one heat radiating pin 912 for increasing an amount of heat radiation. The heat radiating pin 912 is protruded from a lower surface of the buffering member 910 facing the bottom chassis 920. The heat radiating pin 912 may have a pin shape or comb-like profile to increase an area of the heat radiation. The heat radiating pin 912 is exposed through a hole 926 formed through the bottom chassis 920. Thus, the heat generated from an electrode portion of the flat fluorescent lamp 200 does not pass through the bottom chassis 920, but is directly radiated through the heat radiating pin 912, thereby increasing the amount of the heat radiation. Therefore, a temperature of the electrode portion of the flat fluorescent lamp 200 is decreased so that a temperature difference between the electrode portion and a central portion of the flat fluorescent lamp 200 is decreased. When the temperature difference is decreased, mercury may not be concentrated on the central portion, thereby decreasing pinky phenomenon.

In alternative embodiments, a plurality of heat radiating pins 912 may be aligned in a longitudinal direction of the buffering member 910. In one exemplary embodiment, a size or dimension of the heat radiating pins 912 in a direction substantially parallel to a longitudinal direction of the buffering member 910 may be decreased, as a distance from a central line of the buffering member 910 is increased as illustrated in FIG. 12. The dimension of the holes 926 corresponding to the heat radiating pins 912 may also decrease as a distance from a central line of the buffering member 910 increases. Thus, the temperature difference between a center and a side of the buffering member 910 may be decreased.

The bottom chassis 920 includes a bottom plate 922 and a sidewall 924. The sidewall 924 is extended from sides of the bottom plate 922 to form a receiving space to receive the flat fluorescent lamp 200. The bottom chassis 920 may include a strong metal that is resistant to deformation.

The hole 926 through which the heat radiating pin 912 of the buffering member 910 is exposed is formed through the bottom plate 922 of the bottom chassis 920.

As in the illustrated embodiments, the heat generated from the external electrode portion of the flat fluorescent lamp is effectively dissipated using the heat radiating member making contact with the external electrode of the flat fluorescent lamp and the bottom chassis. Thus, the pinky phenomenon on the external electrode portion is reduced or effectively prevented.

This invention has been described with reference to the example embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly comprising:
a flat fluorescent lamp including a lamp body generating light and an electrode portion formed on the lamp body;
a buffering member contacting the electrode portion, the buffering member including at least one hole; and
a bottom chassis including a bottom plate and a sidewall and receiving the flat fluorescent lamp and the buffering member, the bottom chassis further including at least one hole.

2. The backlight assembly of claim 1, wherein the electrode portion comprises a first external electrode on an upper surface of the lamp body and a second external electrode on a lower surface of the lamp body, the buffering member contacting the second external electrode.

3. The backlight assembly of claim 1, further comprising an insulating cover covering the hole of the bottom chassis.

4. The backlight assembly of claim 1, wherein the hole of the bottom chassis is formed through the bottom plate of the bottom chassis.

5. The backlight assembly of claim 4, wherein the hole formed through the bottom plate of the bottom chassis corresponds to the hole of the buffering member.

6. The backlight assembly of claim 1, further comprising a fluorescent layer in the lamp body.

7. The backlight assembly of claim 1, wherein the buffering member comprises carbon.

8. The backlight assembly of claim 1, wherein a heat conductivity of the buffering member is no less than about 3 W/mK.

9. The backlight assembly of claim 1, further comprising a reflecting layer in the lamp body.

10. The backlight assembly of claim 1, further comprising a reflecting layer on an outer surface of the lamp body.

11. The backlight assembly of claim 2, wherein the lamp body comprises:
a first substrate; and
a second substrate combined with the first substrate and forming a plurality of discharge spaces.

12. The backlight assembly of claim 11, wherein each of the first and second external electrodes crosses the discharge spaces.

13. The backlight assembly of claim 1, further comprising:
a diffusion plate on the flat fluorescent lamp and diffusing the light generated from the flat fluorescent lamp; and
at least one optical sheet on the diffusion plate.

14. A backlight assembly comprising:
a flat fluorescent lamp including a lamp body generating light and an electrode portion formed on the lamp body;
a buffering member contacting the electrode portion, the buffering member including at least one groove;
a bottom chassis including a bottom plate and a sidewall and receiving the flat fluorescent lamp and the buffering member, the bottom chassis further including a hole corresponding to the groove of the buffering member; and
a heat radiating member combined with the groove of the buffering member through the hole of the bottom chassis.

15. The backlight assembly of claim 14, wherein the electrode portion comprises a first external electrode on an upper surface of the lamp body and a second external electrode on a lower surface of the lamp body, the buffering member contacting the second external electrode.

16. The backlight assembly of claim 14, wherein the hole of the bottom chassis is formed through the bottom plate of the bottom chassis.

17. The backlight assembly of claim 14, wherein the heat radiating member comprises a heat sink.

18. The backlight assembly of claim 14, wherein the heat radiating member comprises a graphite plate.

19. The backlight assembly of claim 15, wherein the lamp body comprises:
a first substrate; and
a second substrate combined with the first substrate and forming a plurality of discharge spaces.

20. The backlight assembly of claim 19, wherein each of the first and second external electrodes crosses the discharge spaces.

21. A backlight assembly comprising:
a flat fluorescent lamp including a lamp body generating light and an electrode portion formed on the lamp body;
a buffering member contacting the electrode portion, the buffering member including at least one heat radiating pin; and
a bottom chassis including a bottom plate and a sidewall and receiving the flat fluorescent lamp and the buffering member, the bottom chassis further including at least one hole through which the heat radiating pin is exposed.

22. The backlight assembly of claim 21, further comprising a plurality of heat radiating pins arranged in a longitudinal direction of the buffering member, the heat radiating pins being spaced apart from each other by a predetermined distance.

23. The backlight assembly of claim 22, wherein a size of the heat radiating pins is decreased as a distance in a longitudinal direction from a center of the buffering member is increased.

24. The backlight assembly of claim 21, wherein the hole of the bottom chassis is formed through the bottom plate of the bottom chassis.

25. The backlight assembly of claim 21, wherein the buffering member comprises carbon.

26. The backlight assembly of claim 21, wherein the electrode portion comprises a first external electrode on an upper surface of the lamp body and a second external electrode on a lower surface of the lamp body, the buffering member contacting the second external electrode.

27. The backlight assembly of claim 26, wherein the lamp body comprises:
a first substrate; and
a second substrate combined with the first substrate and forming a plurality of discharge spaces.

28. The backlight assembly of claim 27, wherein each of the first and second external electrodes crosses the discharge spaces.

29. A display device comprising:
a backlight assembly supplying light, the backlight assembly comprising:
a flat fluorescent lamp including a lamp body generating the light, a first external electrode on an upper surface of the lamp body and a second external electrode on a lower surface of the lamp body;
a buffering member contacting the second external electrode, the buffering member including at least one hole; and
a bottom chassis including a bottom plate and a sidewall to receive the flat fluorescent lamp and the buffering member, the bottom chassis further including at least one hole; and
a display unit displaying images based on the light generated from the backlight assembly.

30. The display device of claim 29, further comprising an insulating cover that covers the hole of the bottom chassis.

31. The display device of claim 30, wherein the hole is formed through the bottom plate of the bottom chassis.

32. The display device of claim 30, wherein the hole of the bottom plate of the bottom chassis corresponds to the hole of the buffering member.

33. The display device of claim 30, wherein the buffering member comprises carbon.

34. A display device comprising:
a backlight assembly supplying light, the backlight assembly including:
a flat fluorescent lamp including a lamp body generating the light, a first external electrode on an upper surface of the lamp body and a second external electrode on a lower surface of the lamp body;
a buffering member contacting the second external electrode, the buffering member including at least one groove;
a bottom chassis including a bottom plate and a sidewall to receive the flat fluorescent lamp and the buffering member, the bottom chassis further including a hole corresponding to the groove of the buffering member; and
a heat radiating member combined with the groove of the buffering member through the hole of the bottom chassis; and
a display unit displaying images based on the light generated from the backlight assembly.

35. The display device of claim 34, wherein the hole of the bottom chassis is formed through the bottom plate of the bottom chassis.

36. The display device of claim 34, wherein the heat radiating member comprises a heat sink.

37. The display device of claim 34, wherein the heat radiating member comprises a graphite plate.

38. A display device comprising:
a backlight assembly supplying light, the backlight assembly including:
a flat fluorescent lamp including a lamp body generating light, a first external electrode on an upper surface of the lamp body and a second external electrode on a lower surface of the lamp body;
a buffering member contacting the second external electrode, the buffering member including at least one heat radiating pin; and
a bottom chassis including a bottom plate and a sidewall to receive the flat fluorescent lamp and the buffering member, the bottom chassis further including at least one hole through which the heat radiating pin is exposed; and
a display unit displaying images based on the light generated from the backlight assembly.

39. The display device of claim 38, further comprising a plurality of heat radiating pins arranged in a longitudinal direction of the buffering member, the heat radiating pins being spaced apart from each other by a predetermined distance.
